(19) United States
(12) Patent Application Publication
(10) Pub. No.: US 2010/0254372 A1
(43) Pub. Date: Oct. 7, 2010

(54) SYSTEM AND METHOD FOR ENHANCING IMS CENTRALIZED SERVICES

(76) Inventors: Ralf Keller, Wurselen (DE); Jian Wang, Beijing (CN); Kazuhiko Nakada, Tokyo (JP); Alf Heidermark, Saltsjobaden (SE)

Correspondence Address: NIXON & VANDERHYE, PC, 901 NORTH GLEBE ROAD, 11TH FLOOR, ARLINGTON, VA, 22203, US

(21) Appl. No.: 12/665,548

(22) PCT Filed: Jun. 16, 2008
(86) PCT No.: PCT/IB08/01565

§ 371 Date: May 21, 2010

Related U.S. Application Data
(60) Provisional application No. 60/944,581, filed on Jun. 18, 2007.

(51) Int. Cl. H04L 12/66

(52) U.S. Cl. 370/352

(57) ABSTRACT

A system and method of providing an enhanced service in a telecommunications network. The system includes a telecommunications network utilizing a circuit switched and packet switched access capability. The system also includes a sending User Equipment (UE) originating a call to a receiving UE. The sending UE sends an indicator informing the network to wait for further call information before proceeding with a call request towards the receiving UE. The system also includes a control node for routing calls within the network. The control node combines the call information received from the sending UE with call routing information of the call for connecting the call with the receiving UE to form a call request to the receiving UE. Upon receiving the call request message by the receiving UE, the call is connected and a media path is established between the receiving UE and the sending UE.

### TECHNICAL FIELD

The present invention relates generally to communications networks, and in particular, to communications networks that employ systems and methods for enhancing IP Multimedia Subsystem (IMS) centralized services.

### BACKGROUND

Third Generation Partnership Project 2 (3GPP2) specifications, as described in IP Multimedia System (IMS) centralized services (Release 8), 3GPP TR 23.892 specify and define IMS architecture along with a number of enablers that can be used to implement various multimedia services using packet-based bearers. In particular, TR 23.892 addresses an architecture that supports the provision of IMS based services across a variety of Packet Switched (PS) domain or Circuit Switched (CS) domain access networks.

With this transition to PS domain access networks from CS domain access networks, there are several services which may not be available to users. Currently, where an IMS Centralized Services (ICS) User Equipment (UE) only has CS access, the ICS UE does not have many services available as compared to other UEs having access to PS domain access networks. A system and method are needed which provides as many services as possible to a UE with minimal modifications to a network.

### SUMMARY

The present invention provides a system and method which provides enhanced services in a telecommunications network. Thus, in one embodiment, the present invention is directed to a system which includes a telecommunications network utilizing a circuit switched and packet switched access capability. The system also includes a sending User Equipment (UE) originating a call to a receiving UE. The sending UE sends an indicator informing the network to wait for further call information before proceeding with a call request towards the receiving UE. The system also includes a control node for routing calls within the network. The control node combines the call information received from the sending UE with call routing information of the call for connecting the call with the receiving UE to form a call request to the receiving UE. Upon receiving the call request message by the receiving UE, the call is connected and a media path is established between the receiving UE and the sending UE.

In another embodiment, the present invention is directed to a method of providing an Instant Picture Presentation service by utilizing CS and PS access capability. The method begins by the sending UE sending an indicator informing the network to wait for further call information before proceeding with a call request towards the receiving UE. The sending UE then initiates a call with the receiving UE. The call is then routed within the network. Responsive to the routing of the call, a call request is sent to a control node within the telecommunications network. Call information is sent by the sending UE to the control node. The control node then combines the call information with the call routing information to form a call request message for connecting the call with the receiving UE. The call request message is then sent to the receiving UE. The call is connected between the receiving UE and the sending UE. A media path is established between the receiving UE and the sending UE.

In still another embodiment, the present invention is directed to a node within a telecommunications network utilizing circuit switched and packet switched access capability to provide an enhanced service. The node is capable of receiving an indicator from a sending UE originating a call to a receiving UE. The indicator informs the network to wait for further call information before proceeding with a call request towards the receiving UE. The node combines the call information with call routing information to form a call request to the receiving UE. The node sends the call request message upon receiving both the call information and call routing information.

In another embodiment, the present invention is directed to a system and method providing Customized Alert Tone (CAT) service to a receiving UE from a sending UE in a telecommunications network. The method begins with the sending UE initiating a call to the receiving UE. The call is routed through a control node. Next, the control node establishes a Session Initiated Protocol (SIP) session with a Media Resource Function (MRF). The CAT service is then performed from the MRF to the sending UE.

### BRIEF DESCRIPTION OF THE DRAWINGS

FIG. 1 (prior art) illustrates an existing telecommunications network;

FIG. 2 is a signaling diagram illustrating an exemplary call flow for a Customized Alerting Tone (CAT) service in one embodiment of the present invention;

FIGS. 3A-3D are flow charts illustrating the steps for executing a call utilizing a CAT service according to the teachings of the present invention;

FIG. 4 is a signaling diagram illustrating the service of Instant Picture Presentation by utilizing CS and PS access capability in an embodiment of the present invention; and

FIGS. 5A-5D are flow charts illustrating the steps for executing a call utilizing a Instant Picture Presentation by utilizing CS and PS access capability according to the teachings of the present invention.

### DETAILED DESCRIPTION

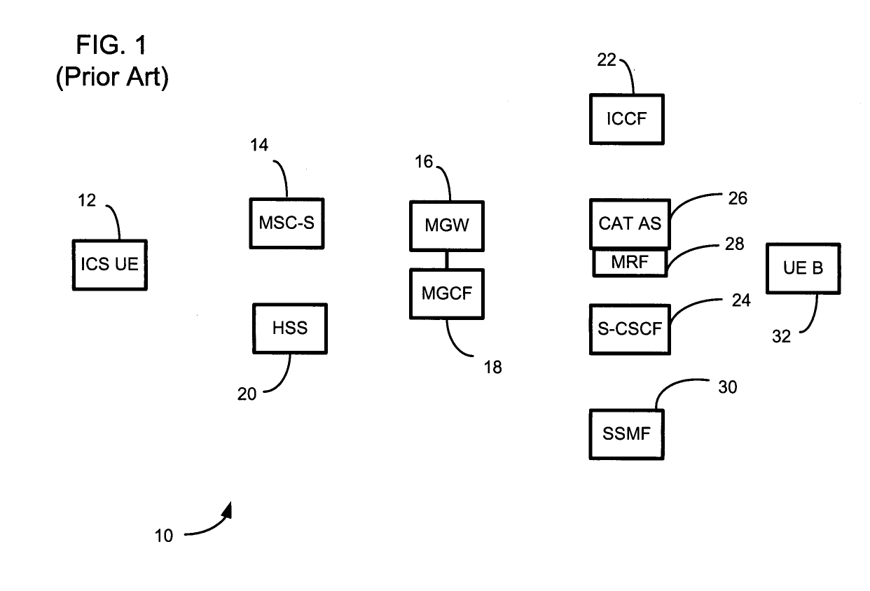

The present invention is a system and method of enhancing IMS centralized services. FIG. 1 illustrates an existing telecommunications network 10. An ICS UE 12 communicates with a Mobile Switching Center Server (MSC-S) 14. The MSC-S having a Media Gateway Control Function (MGCF) 18 utilizes a Media Gateway (MGW) 16 to communicate within the telecommunications network. The network includes a Home Subscriber Server (HSS) 20. An IMS CS Control Function (ICCF) 22 provides functions necessary for provision of IMS services for calls originated or terminated over CS access networks and for calls transferred between CS and PS access networks. The telecommunications network also includes a Serving Call Service Control Function (S-CSCF) 24. The network may also include a Customized Alert Tone (CAT) Access Stratum (AS) 26 having a Media Resource Function (MRF) 28. An SSMF 30 (Session Split Merger Function—controls whether one session has to be split into two or whether two sessions have to be merged into one) may also be utilized in the network. In the scenarios described below, the ICS UE 12 calls a UE B 32.

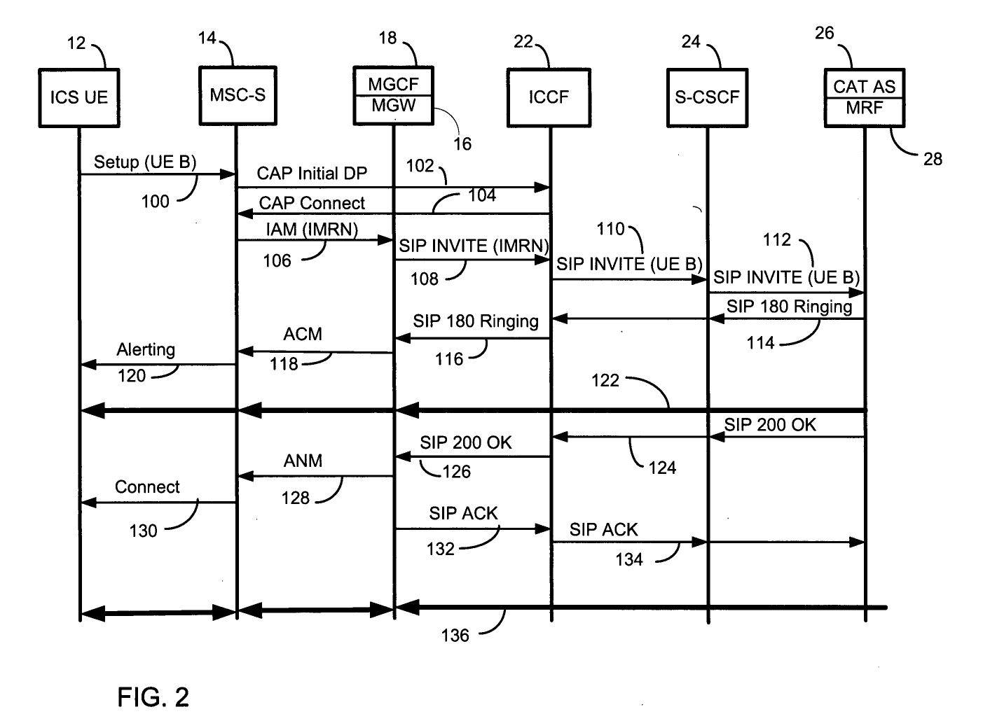

FIG. 2 is a signaling diagram illustrating an exemplary call flow for a Customized Alerting Tone (CAT) service in one embodiment of the present invention. In 100, the ICS UE 12 initiates a normal CS call setup for the UE B 32 towards the MSC-S 14. The ICS UE only has CS access. Next, in 102, the MSC-S sends a Customized Application for Mobile network Enhanced Logic (CAMEL) or CAMEL Application Part (CAP) initial Dial Pulse (DP) message, which originates a trigger request, to the ICCF 22 to retrieve an ICS Call initiation Result (IMRN) for the ICCF 22. In 104, the ICCF 22 returns an IMRN to the MSC-S 14. In 106, the MSC-S routes the call to the MGCF 18 by sending an Initial Address Message (IAM). The MGCF 18 then sends a Session Initiated Protocol (SIP) INVITE message to the ICCF 22 by Packet Signaling Information (PSI) routing in 108. In 110, the ICCF sends a SIP INVITE message towards the S-CSCF 24 serving the UE B 32. Next, as the UE B 32 is a CAT subscriber, the S-CSCF 24 forwards the message to the CAT AS 26 via an iFC (initial Filter Criteria; downloaded from the HSS, includes a list of application servers to be invoked) checking in 112. When the UE B phone starts ringing, a SIP 180 ringing is sent to the CAT AS 26. The CAT AS initiates a session with the MRF 28 requesting the MRF to generate the CAT for the ICS UE, according to a CAT procedure. Next, in 114, the CAT AS 26/MRF 26 inserts a P-early-media and forwards the SIP 180 ringing message from the UE B to the ICCF 22 via the S-CSCF 24. In 116, the ICCF 22 forwards the SIP 180 ringing message to the MGCF 18. The MGCF 18 and MGW 16 do not generate local ring-back tone towards the ICS UE 12. The MGCF 18 sends an Address Complete Message (ACM) to the MSC-S 14 at 118. In 120, the MSC-S sends an Alerting message to the ICS UE 12. The customized CAT is then played from the MRF 26 to the ICS UE 12 at 122.

When the CAT AS receives a SIP 200 OK message from UE B (not shown), the MRF 28 is informed to stop playing the CAT. The CAT AS 26 then forwards the SIP 200 OK message to the ICCF 22 through the S-CSCF 24 at 124. At 126, the ICCF sends the SIP 200 OK message to the MGCF 18. The MGCF 18 then sends an ANM (answer indication) to the MSC-S 14 at 128. The MSC-S then sends a Connect message to the ICS UE 12 at 130. In 132, the MGCF 18 sends a SIP ACK message to the ICCF 22. In 134, the ICCF 22 sends a SIP ACK message towards the UE B via the S-CSCF 24. The media is then established e2e (end to end) at 136. The present invention, as depicted in FIG. 2, supports customized alerting tone service without modifying the UE or the network.

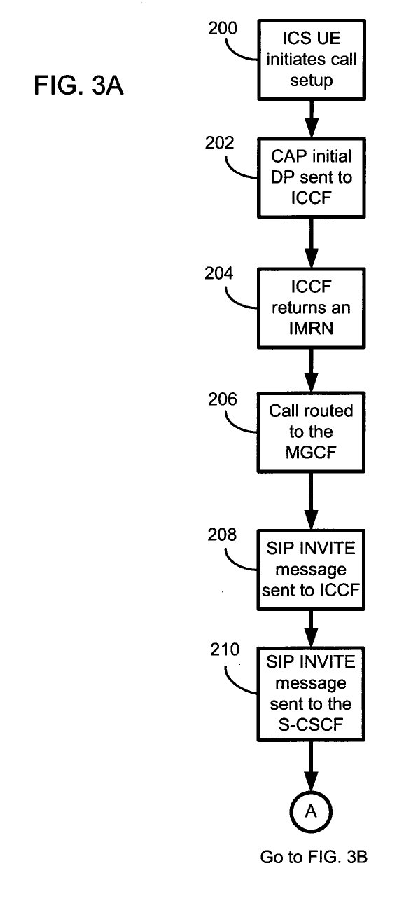

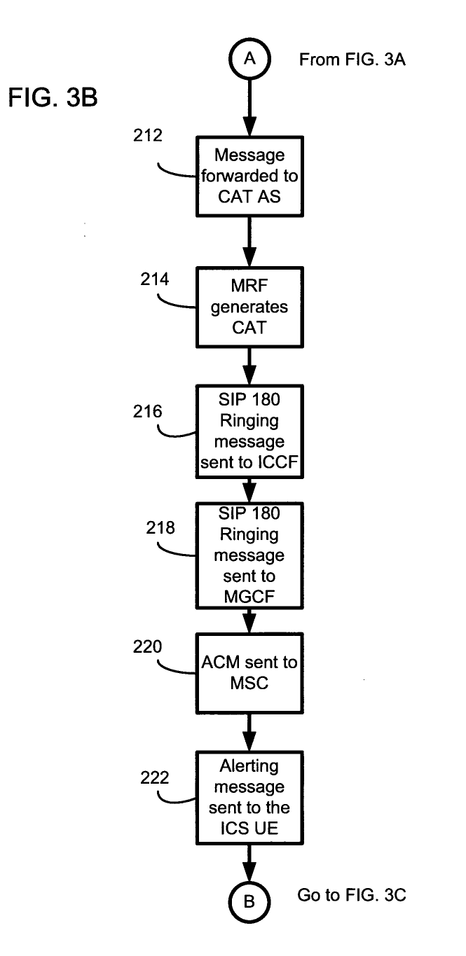

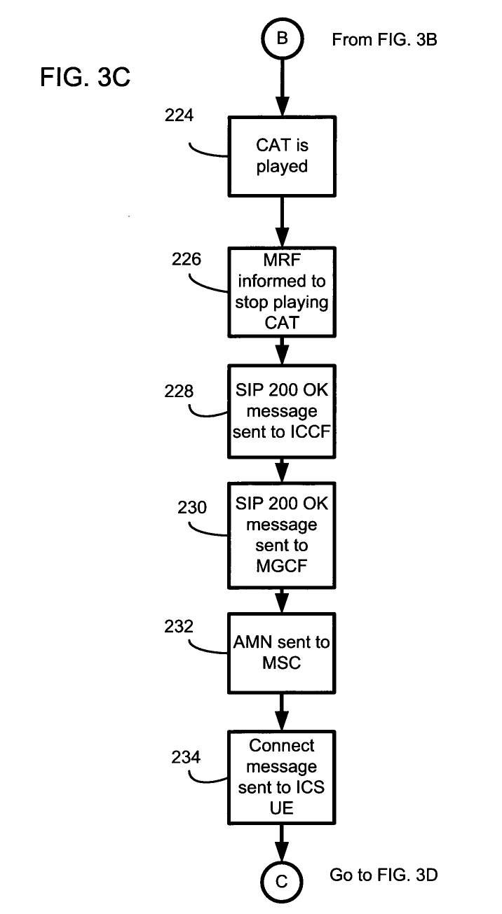

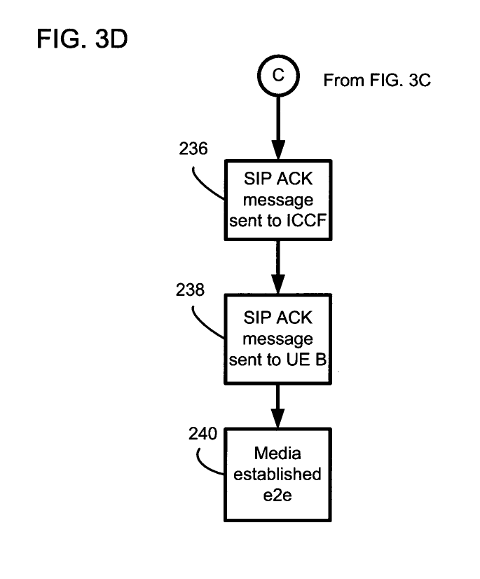

FIGS. 3A-3D are flow charts illustrating the steps for executing a call utilizing a CAT service according to the teachings of the present invention. With reference to FIGS. 1-3, the method of the present invention will now be explained. The method begins in step 200 where the ICS UE 12 initiates a normal CS call setup for the UE B 32 towards the MSC-S 14. The ICS UE only has CS access. Next, in step 202, the MSC-S sends a CAT initial DP message, which originates a trigger request, to the ICCF 22 to retrieve an ICS Call initiation Result (IMRN) for the ICCF 22. In step 204, the ICCF 22 returns an IMRN to the MSC-S 14. In step 206, the MSC-S routes the call to the MGCF 18 by sending an Initial Address Message (IAM) to the MGCF 18. Next, in step 208, the MGCF 18 sends a Session Initiated Protocol (SIP) INVITE message to the ICCF 22. In turn, in step 210, the ICCF sends a SIP INVITE message towards the S-CSCF 24 serving the UE B 32. In step 212, the S-CSCF 24 forwards the message to the CAT AS 26. When the UE B phone rings, a SIP 180 ringing is sent to the CAT AS 26. In step 214, the CAT AS initiates a session with the MRF 28 requesting the MRF to generate the CAT for the ICS UE.

In step 216, the CAT AS 26/MRF 26 forwards the SIP 180 ringing message from the UE B to the ICCF 22 via the S-CSCF 24. In 218, the ICCF 22 forwards the SIP 180 ringing message to the MGCF 18. The MGCF 18 and MGW 16 do not generate local ring-back tone towards the ICS UE 12. Next, in step 220, the MGCF 18 sends an ACM to the MSC-S 14. In step 222, the MSC-S sends an Alerting message to the ICS UE 12. Next, the customized CAT is played from the MRF 26 to the ICS UE 12 at step 224.

In step 226, when the CAT AS receives a SIP 200 OK message from the UE B (not shown), the MRF 28 is informed to stop playing the CAT. In step 228, the CAT AS 26 forwards the SIP 200 OK message to the ICCF 22 through the S-CSCF 24. In step 230, the ICCF sends the SIP 200 OK message to the MGCF 18. The MGCF 18 then sends an ANM to the MSC-S 14 at step 232. In step 234, the MSC-S sends a Connect message to the ICS UE 12. Next, in step 236, the MGCF 18 sends a SIP ACK message to the ICCF 22. The ICCF 22 then sends a SIP ACK message towards the UE B via the S-CSCF 24 at step 238. The media is then established e2e at step 240.

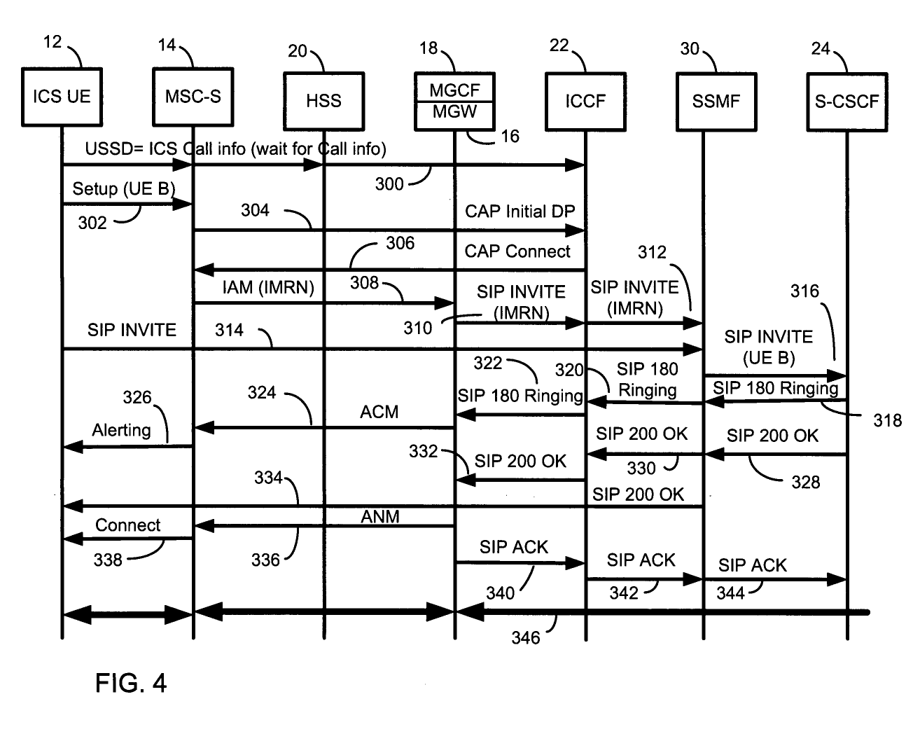

In another embodiment of the present invention, when a PS access (with a limited capability) network is available for the ICS UE, the ICS UE may provide enhanced service to the user by combining CS and PS access together. FIG. 4 is a signaling diagram illustrating the service of Instant Picture Presentation by utilizing CS and PS access capability in an embodiment of the present invention. When an ICS UE 12 desires to initiate a call with an instant picture presentation, in 300, the ICS UE first sends an indication via the Unstructured Supplemental Service Data (USSD) (not shown) to the ICCF 22 informing the network to wait for Call-info in a SIP session before proceeding with an ICS call request towards the UE B 32. Since the ICS UE is initiating the ICS call request and the SIP session, it can give the network information in the indication about the upcoming ICS call request and SIP session, which may be used by the network for the identification and correlation of the requests. Next, in 302, the ICS UE 12 initiates a normal CS call towards the MSC-S 14. In 304, the MSC-S sends a CAMEL originating trigger request to the ICCF to retrieve an IMRN for the ICCF. Next, the ICCF returns an IMRN to the MSC-S at 306. In 308, the MSC-S 14 routes the call to the MGCF 18. Next, in 310, the MGCF sends a SIP INVITE message to the ICCF by PSI routing. Based on the “wait” indication received in 300, the ICCF 22 includes a tag in the SIP INVITE message and forwards it to the SSMF 30 in 312. The SSMF then holds the processing of the ICS call request according to the tag.

Next, in 314, the ICS UE 12 sends a SIP INVITE message which includes Call-Info. This INVITE message adds an icon to the session which has already been established in step 2 over the PS network to the SSMF 30. The SSMF may then correlate this SIP session with the on-hold ICS call request. In 316, the SSMF combines the two requests and forms a new SIP INVITE message including the Call-info on icon and sends the message to the UE B 32 via the S-CSCF 24. Next, the UE B 32 sends a SIP 180 Ringing message to the SSMF 30 in 318. The SSMF, at 320, then sends the SIP 180 Ringing message to the ICCF 22. In 322, the ICCF sends the SIP 180 Ringing message to the MGCF 18. The MGCF sends an ACM to the MSC-S 14 at 324. At 326, the MSC-S sends an Alerting message to the ICS UE 12. At 328, the UEB sends a SIP 200 OK message to the SSMF 30 via the S-CSCF 24. Next, in 330, the SSMF sends the SIP 200 OK message to the ICCF 22. In 332, the ICCF sends the SIP 200 OK message to the MGCF 18. In addition, at 334, the SSMF sends an SIP 200 OK message to the ICS UE 12. At 336, the MGCF 18 sends an ANM to the MSC-S 14. The MSC-S then sends a Connect message to the ICS UE 12 at 338. At 340, the MGCF sends an SIP ACK message to the ICCF 22. The ICCF sends an SIP ACK message to the SSMF 30 at 342. At 344, the SSMF sends the SIP ACK message to the UE-B via the S-CSCF 24. At 346, the media path is established e2e.

In the embodiment described in FIG. 4, the enhancement is the USSD capability to express the “wait” indication. This enhancement provides additional services without large modifications to the network. It should be understood that the Instant Picture Presentation Service is exemplary only as the present invention may be utilized to provide other enhanced services besides the Instant Picture Presentation Service to users; e.g., adding a business card.

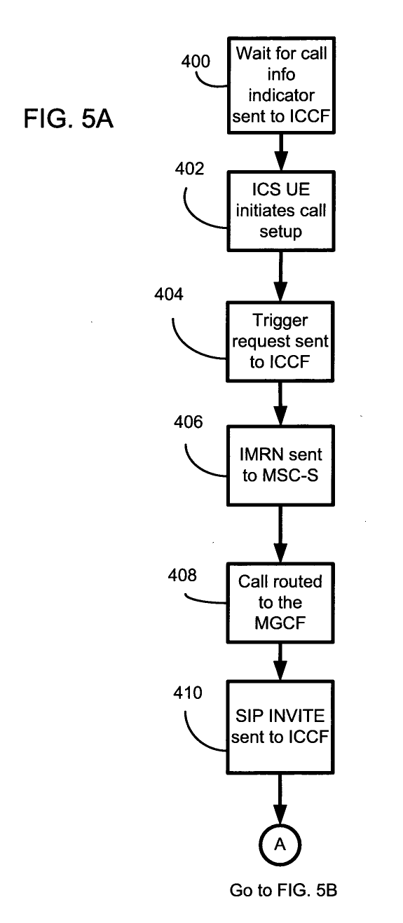

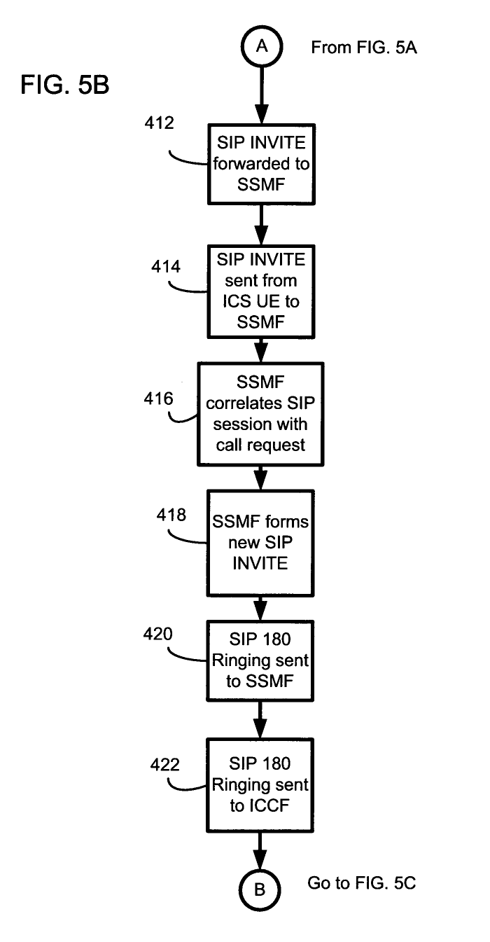

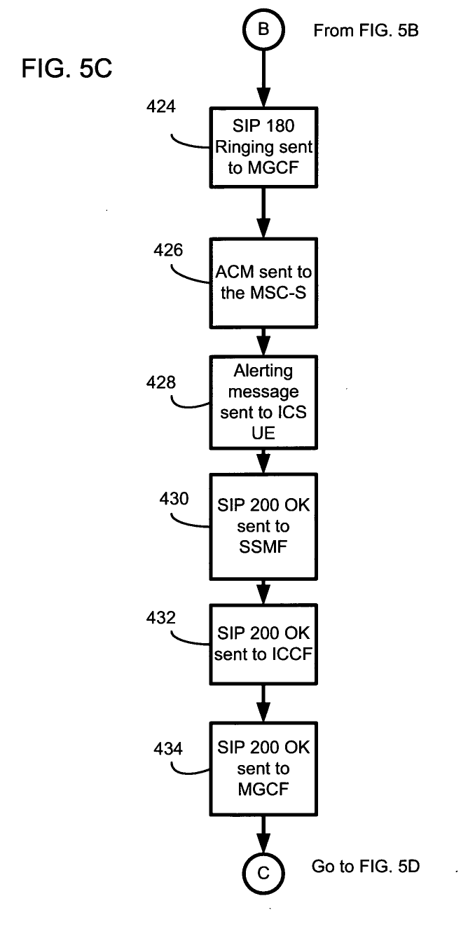

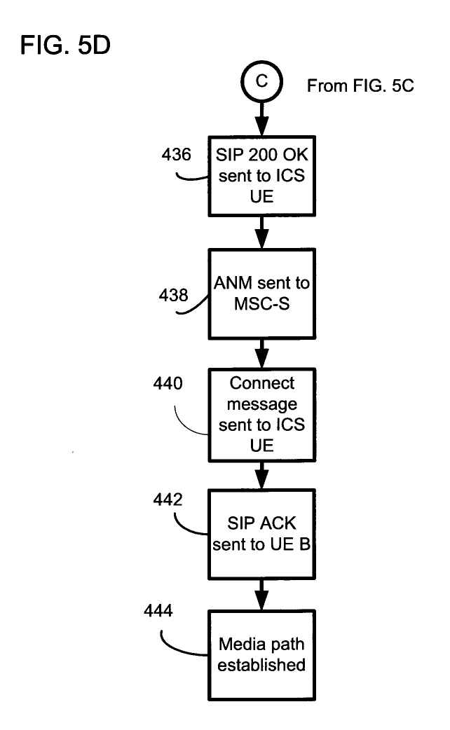

FIGS. 5A-5D are flow charts illustrating the steps for executing a call utilizing a Instant Picture Presentation by utilizing CS and PS access capability according to the teachings of the present invention. With reference to FIGS. 1, 4 and 5, the method of the present invention will now be explained. The method begins with step 400 where, an ICS UE 12 desiring to initiate a call with an instant picture presentation first sends an indication via the USSD (not shown) to the ICCF 22 informing the network to wait for Call-info in a SIP session before proceeding with an ICS call request towards the UE B 32. Since the ICS UE is initiating the ICS call request and the SIP session, it can give the network information in the indication about the upcoming ICS call request and SIP session, which may be used by the network for the identification and correlation of the requests. Next, in step 402, the ICS UE 12 initiates a normal CS call towards the MSC-S 14. In step 404, the MSC-S sends a CAMEL originating trigger request to the ICCF to retrieve an IMRN for the ICCF. Next, in step 406, the ICCF returns an IMRN to the MSC-S. In step 408, the call is routed to the MGCF 18. The MGCF then sends a SIP INVITE message to the ICCF by PSI routing in step 410. Based on the “wait” indication received in step 400, the ICCF 22 includes a tag in the SIP INVITE message and forwards it to the SSMF 30 in step 412. The SSMF then holds the processing of the ICS call request according to the tag.

Next, in step 414, a SIP INVITE message is sent from the ICS UE 12. The message includes Call-Info with purpose=icon over the PS network to the SSMF 30. The SSMF correlates this SIP session with the held ICS call request in step 416. Next, in step 418, the SSMF combines the two requests and forms a new SIP INVITE message including the Call-info on icon and sends the message to the UE B 32 via the S-CSCF 24. In step 420, the UE B 32 sends a SIP 180 Ringing message to the SSMF 30. The SSMF, at step 422, then sends the SIP 180 Ringing message to the ICCF 22. In step 424, the ICCF sends the SIP 180 Ringing message to the MGCF 18. At step 426, the MGCF sends an ACM to the MSC-S 14. Next, at step 428, the MSC-S sends an Alerting message to the ICS UE 12. At step 430, the UE B sends a SIP 200 OK message to the SSMF 30 via the S-CSCF 24. Next, in step 432, the SSMF sends the SIP 200 OK message to the ICCF 22. In step 434, the ICCF sends the SIP 200 OK message to the MGCF 18. In addition, at step 436, the SSMF sends an SIP 200 OK message to the ICS UE 12. At 438, the MGCF 18 sends an ANM to the MSC-S 14. The MSC-S then sends a Connect message to the ICS UE 12 at step 440. Nest, in step 442, the MGCF sends an SIP ACK message to the ICCF 22, which forwards it to the SSMF 30 and the UE-B via the S-CSCF 24. In step 444, the media path is established e2e.

The present invention may provide more services to users without significant modification to the ICS architecture. The present invention may be utilized with or without limited PS access together with CS access using the I1-cs option.

The present invention may of course be carried out in other specific ways than those herein set forth without departing from the essential characteristics of the invention. The present embodiments are, therefore, to be considered in all respects as illustrative and not restrictive and all changes coming within the meaning and equivalency range of the appended claims are intended to be embraced therein.

1. A method of providing an enhanced service to a receiving user equipment (UE) from a sending UE in a telecommunications network utilizing circuit switched and packet switched access capability, the method comprising the steps of:
sending an indicator informing the network to wait for further call information before proceeding with a call request towards the receiving UE;
initiating, by the sending UE, a call with the receiving UE;
routing the call within the network;
responsive to the routing of the call, sending a call request to a control node within the telecommunications network;
sending, by the sending UE, call information to the control node;
combining, by the control node, the call information with the call routing information to form a call request message for connecting the call with the receiving UE;
sending the call request message to the receiving UE;
connecting the call between the receiving UE and the sending UE; and
establishing a media path between the receiving UE and the sending UE.

2. The method of providing an enhanced service according to claim 1 wherein the step of sending, by the sending UE, call information is sent via CS signaling and Session Initiated Protocol is used to amend the call information.

3. The method of providing an enhanced service according to claim 1 wherein the step of sending a call request to the control node includes conducting a Session Initiated Protocol (SIP) session with the control node.

4. The method of providing an enhanced service according to claim 1 wherein the control node includes a SSMF (Session Split Merger Function).

5. The method of providing an enhanced service according to claim 1 wherein the call request is an IP Multimedia Subsystem Centralized Services (ICS) call request.

6. The method of providing an enhanced service according to claim 1 wherein the enhanced service further comprises one of an instant picture presentation service, a business card or a personalized ring tone.

7. The method of providing an enhanced service according to claim 1 wherein the indicator is sent within a transport message, the transport message being an Unstructured Supplemental Service Data (USSD) message or a Short Message Service (SMS) message.

8. A system for providing an enhanced service, the system comprising:
a telecommunications network utilizing a circuit switched and packet switched access capability;
a sending UE originating a call to a receiving UE, the sending UE having
means for sending an indicator informing the network to wait for further call information before proceeding with a call request towards the receiving UE and
means for sending call information; and
a control node for routing calls within the network,
wherein the control node combines the call information received from the sending UE with call routing information of the call for connecting the call with the receiving UE to form a call request to the receiving UE;
whereby upon receiving the call request message by the receiving UE, connecting the call and establishing a media path between the receiving UE and the sending UE.

9. The system of providing an enhanced service according to claim 8 wherein the sending UE conducts a Session Initiated Protocol (SIP) session with the control node.

10. The system for providing an enhanced service according to claim 8 wherein the control node includes a SSMF (Session Split Merger Function).

11. The system for providing an enhanced service according to claim 8 wherein the call request is an IP Multimedia Subsystem Centralized Services (ICS) call request.

12. The system for providing an enhanced service according to claim 8 wherein the enhanced service is an instant picture presentation service.

13. The system for providing an enhanced service according to claim 8 wherein the indicator is within an Unstructured Supplemental Service Data (USSD) message or a Short Message Service (SMS) message.

14. A node within a telecommunications network utilizing circuit switched and packet switched access capability, the node comprising:
means for receiving an indicator from a sending UE originating a call to a receiving UE, the indicator informing the network to wait for further call information before proceeding with a call request towards the receiving UE and
means for sending call information;
means for receiving call information received from the sending UE;
means for combining the call information with call routing information to form a call request to the receiving UE; and
means for sending the call request message upon receiving both the call information and call routing information.

15. The node according to claim 14, wherein the enhanced service is an instant picture presentation service.

16. The node according to claim 14, wherein the indicator is within an Unstructured Supplemental Service Data (USSD) message or Short Message Service (SMS) message.

17. A method of providing Customized Alert Tone (CAT) service to a receiving user equipment (UE) from a sending UE having circuit switch access in a telecommunications network, the method comprising the steps of:
initiating a call from the sending UE to the receiving UE; routing the call through a control node;
establishing, by the control node, a Session Initiated Protocol (SIP) session with a Media Resource Function (MRF); and
performing the CAT service from the MRF to the sending UE.

18. The method of providing CAT service according to claim 17 further comprising the steps of:
responsive to an acknowledgment message from the receiving UE, connecting the call between the sending UE and the receiving UE; and
establishing a media connection between the sending UE and the receiving UE.

19. The method of providing CAT service according to claim 17 wherein the step of establishing by the control node a SIP session includes establishing a SIP session with a media gateway.

20. A system for providing Customized Alert Tone (CAT) service in a telecommunications network, the system comprising:
a telecommunications network utilizing circuit switched and packet switched access capability;
a sending UE originating a call to a receiving UE;
a control node for routing the call;
a Media Resource Function (MRF) operating within the network;
means for establishing a Session Initiated Protocol (SIP) session by the control node with a MRF; and
means for performing the CAT service from the MRF to the sending UE.

21. The system for providing CAT service according to claim 20 further comprising:
responsive to an acknowledgment message received from the receiving UE, means for connecting the call between the sending UE and the receiving UE; and
means for establishing a media connection between the sending UE and the receiving UE.

22. The system for providing CAT service according to claim 22 wherein the means for establishing by the control node a SIP session includes establishing a SIP session with a media gateway associated with the MRF.
